(19) United States
(12) Patent Application Publication
(10) Pub. No.: US 2026/0149866 A1
(43) Pub. Date: May 28, 2026

(54) IMAGE PICKUP APPARATUS, EXPOSURE CONTROL METHOD, AND STORAGE MEDIUM

(71) Applicant: CANON KABUSHIKI KAISHA, Tokyo (JP)

(72) Inventor: YOMA KURIKI, Tokyo (JP)

(21) Appl. No.: 19/385,443

(22) Filed: Nov. 11, 2025

(30) Foreign Application Priority Data
Nov. 25, 2024 (JP) 2024-204735

(51) Int. Cl. H04N 23/611; H04N 23/63; H04N 23/67; H04N 23/73

(52) U.S. Cl. CPC H04N 23/611; H04N 23/631; H04N 23/633; H04N 23/671; H04N 23/73

(57) ABSTRACT

An image pickup apparatus enabling natural exposure tracking when an in-focus position is moved by an MF operation is provided. The image pickup apparatus including a lens unit equipped with a changing member for changing a current in-focus position includes an image sensor to capture an image, a detecting unit that detects subjects from the image, an obtaining unit that obtains information corresponding to positions of the detected subjects, a calculating unit that calculates information about luminance of the detected subjects, and a control unit that, when first and second subjects have been detected, obtains information corresponding to positions of the first and second subjects, calculates information about luminance of the first and second subjects, and performs exposure control when an in-focus position moves based on the information about the luminance of the first and second subjects and the information corresponding to the positions of the first and second subjects.

### BACKGROUND

### Field of the Technology

The present disclosure relates to an image pickup apparatus, an exposure control method, and a storage medium, and more particularly to an image pickup apparatus, an exposure control method, and a storage medium that perform automatic exposure control when a user causes an in-focus position to move with respect to different subjects within an angle of view by using a manual focus operation (an MF operation).

### Description of the Related Art

Conventionally, in photographing by using a digital camera (hereinafter, simply referred to as “a camera”), exposure control is performed automatically by using an auto exposure function (an AE function). As an AE method, a method of performing exposure control so that a subject (such as a person's face) that has been detected by a camera has an appropriate brightness has been known. Here, in the case where there are a plurality of subjects within an angle of view, a method has been known in which a main subject is determined based on, for example, the size of the subject, and the exposure is adjusted with respect to the main subject (for example, see Japanese Laid-Open Patent Publication (kokai) No. 2021-105850).

In addition, there are two known methods of focus control in cameras: auto focus (AF), in which the camera automatically adjusts the focus, and manual focus (MF), in which a user is able to arbitrarily move the in-focus position.

Here, consider a case where there is a difference in the depth of field (hereinafter, referred to as “a depth difference”) within the angle of view and there are two persons with different brightness levels.

With respect to such a case (a scene), for example, Japanese Laid-Open Patent Publication (kokai) No. 2008-172516 has proposed a method of capturing images while changing the in-focus position before photographing, detecting an in-focus region of each image, and performing photometry, and by using this method, it is possible to adjust the exposure with respect to each in-focus region when the in-focus position is moved.

However, in the technique disclosed in Japanese Laid-Open Patent Publication (kokai) No. 2008-172516, when a user has moved the in-focus position at an arbitrary speed by using an MF operation, exposure control that takes the arbitrary speed into consideration is not performed.

### SUMMARY

The present disclosure provides an image pickup apparatus, an exposure control method, and a storage medium that enable natural exposure tracking in a case where an in-focus position is moved by an MF operation.

Accordingly, an aspect of the present disclosure provides an image pickup apparatus including a lens unit equipped with a changing member for changing a current in-focus position by a user operation, the image pickup apparatus comprising an image sensor configured to capture an image, and at least one processor or circuit and a memory storing instructions to cause the at least one processor or circuit to perform operations of the following units: a detecting unit that detects subjects from the image, a subject position obtaining unit that obtains information corresponding to positions of the subjects that have been detected by the detecting unit, a calculating unit that calculates information about luminance of the subjects that have been detected by the detecting unit, and a control unit that, in a case where a first subject and a second subject have been detected as the subjects by the detecting unit, obtains information corresponding to a position of the first subject and information corresponding to a position of the second subject by the subject position obtaining unit, calculates information about luminance of the first subject and information about luminance of the second subject by the calculating unit, and performs exposure control when an in-focus position moves based on the information about the luminance of the first subject, the information about the luminance of the second subject, the information corresponding to the position of the first subject, and the information corresponding to the position of the second subject.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram that illustrates the positional relationship between a camera and two persons in a scene where there is a depth difference within the angle of view between two persons.

FIG. 2 is a diagram that illustrates an image to be obtained by the camera in the scene of FIG. 1.

FIG. 3 is a diagram that illustrates images to be obtained by the camera when an in-focus position is moved from the person on the front side to the person on the deep side in the scene of FIG. 1.

FIG. 4 is a block diagram that illustrates a hardware configuration of a camera as an image pickup apparatus according to a first embodiment of the present disclosure.

FIG. 5 is a diagram that illustrates a photographing scene assumed in the first embodiment.

FIG. 6 is a flowchart of an exposure control processing according to the first embodiment.

FIG. 7 is a diagram that illustrates the positional relationship between the camera and persons who are within an angle of view, and the current in-focus position by an MF operation, in the photographing scene of FIG. 5.

FIG. 8 is a diagram that illustrates images to be recorded and photographed during the MF operation in the photographing scene of FIG. 5.

FIG. 9 is a graph that shows a change in a third photometric value M3 during the MF operation in the photographing scene of FIG. 5.

FIG. 10 is a flowchart of an exposure control processing according to a second embodiment of the present disclosure.

FIG. 11 is a diagram for explaining a photographing scene with a deep depth of field assumed in a third embodiment of the present disclosure.

FIG. 12 is a diagram that illustrates the positional relationship including a tracking start threshold value and a tracking end threshold value in the photographing scene of FIG. 11.

FIG. 13 is a graph that shows the relationship between a third photometric value M′3 and the in-focus position according to the third embodiment when the tracking start threshold value and the tracking end threshold value are used.

FIG. 14 is a flowchart of an exposure control processing according to the third embodiment.

FIG. 15 is a screen example in a case where a user sets the tracking start threshold value and the tracking end threshold value which are shown in FIG. 12.

FIG. 16 is a flowchart of an exposure control processing according to a fourth embodiment of the present disclosure.

FIG. 17 is a screen example in a case where the user selects two subjects which are targets in a step S1604 of FIG. 16.

FIG. 18 is a diagram for explaining a photographing scene assumed in a fifth embodiment of the present disclosure in which a plurality of subjects that are candidates for a second subject have the same priority.

FIG. 19 is a flowchart of an exposure control processing according to the fifth embodiment.

FIG. 20 is a flowchart of an exposure control processing according to a sixth embodiment of the present disclosure.

### DESCRIPTION OF THE EMBODIMENTS

The present disclosure will now be described in detail below with reference to the accompanying drawings showing embodiments thereof.

Hereinafter, embodiments will be described in detail with reference to the accompanying drawings. It should be noted that the following embodiments do not limit the invention as defined by the claims. Although the embodiments describe a plurality of features, not all of the plurality of features are essential to the present disclosure, and the plurality of features may be combined in any desired manner. Furthermore, in the accompanying drawings, the same or similar configurations (components) are given the same reference numerals, and duplicate descriptions will be omitted.

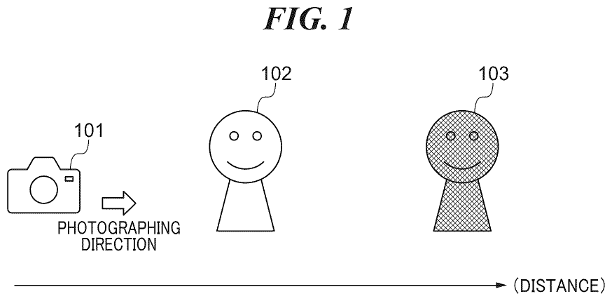

First, a photographing scene that the present disclosure aims to address will be described. As an example of the photographing scene, consider a case where there is a depth difference within the angle of view between two persons. The positional relationship between a camera and the two persons in this case is shown in FIG. 1. In this photographing scene, as shown in FIG. 1, a person 102 is located on the front side with respect to a camera 101, and a person 103 is located on the deep side with respect to the camera 101. It should be noted that in the scene of FIG. 1, the person 103 is in a darker position than the person 102 due to the influence of lighting.

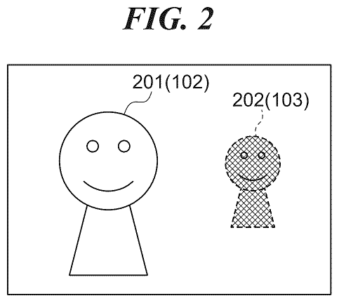

An image to be obtained by the camera 101 in this case is shown in FIG. 2. It should be noted that an image 201 of the person 102 in focus is represented by solid lines, and an image 202 of the person 103 out of focus is represented by dotted lines.

With respect to such a scene, for example, Japanese Laid-Open Patent Publication (kokai) No. 2008-172516 has proposed the method of capturing images while changing the in-focus position before photographing, detecting the in-focus region of each image, and performing photometry, and by using this method, it is possible to adjust the exposure with respect to each in-focus region when the in-focus position is moved.

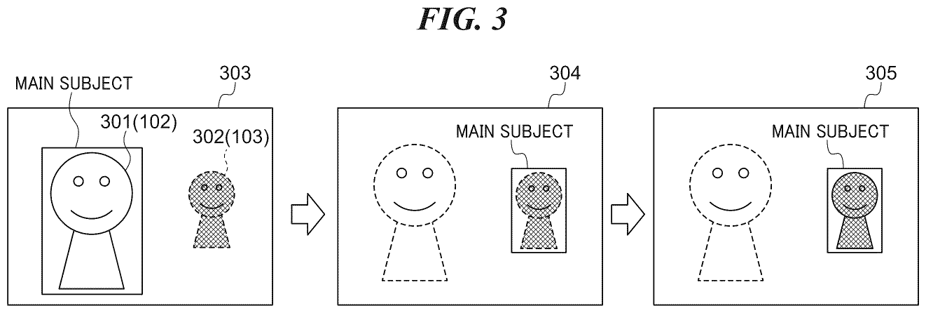

Here, a case where the in-focus position is moved from the person 102 to the person 103 by manual focus (MF) in FIG. 2 will be described with reference to FIG. 3.

FIG. 3 shows images to be obtained while the in-focus position is being moved. When the in-focus position moves from a state 303, in which an image 301 of the person 102 on the front side is in focus, to an image 302 of the person 103 on the deep side, first, although neither the person 102 nor the person 103 is completely in focus, the degree of in-focus of the person 102 is smaller than the degree of in-focus of the person 103. Thereafter, transitioning to a state 304, in which the image 302 of the person 103 on the deep side is in focus.

In this case, consider a case where a main subject is determined by using the method disclosed in Japanese Laid-Open Patent Publication (kokai) No. 2021-105850. In this case, the state 303, in which the person 102 on the front side is the main subject, transitions to the state 304, in which the person 103 that is the main subject has been in focus, via a state, in which the main subject is switched to the person 103.

Furthermore, optimal auto exposure (optimal AE) with respect to each of the states 303 to 305 is as follows. First, in the state 303, since the person 102 on the front side becomes the main subject, the exposure is adjusted to match the image 301 of the person 102. Next, the exposure control works so that in the state 304, at the moment when the main subject is switched to the image 302 of the person 103 on the deep side, the exposure is adjusted to match the image 302 of the person 103. Here, since the luminance of the image 302 of the person 103 is lower than that of the image of the person 102, the exposure transitions to becoming brighter. Thereafter, until the state 305, the image 302 of the person 103 on the deep side becomes the main subject, and therefore the operation with the exposure adjusted to match the image 302 of the person 103 is continued.

Regarding the exposure control when the in-focus position is moved as shown in FIG. 3, consider a case where the user has moved the in-focus position at a low speed by using an MF operation. Here, the MF operation refers to an operation in which the user arbitrarily moves the in-focus position by, for example, rotating a focus ring provided on a lens attached to the camera, and the in-focus position changes at a speed corresponding to the speed of rotation of the focus ring.

If the user performs the MF operation at a low speed in response to the operation of the exposure control in FIG. 3 described above, the in-focus position will change at a low speed, but the exposure control will become an operation that changes suddenly at the time point when the main subject is switched (in the state 304). It should be noted that since the speed at which the in-focus position changes due to the MF operation is set arbitrarily by the user, it is difficult for the camera to predict it. Therefore, the speed at which the in-focus position changes and the speed at which the exposure changes may be different, resulting in unnatural exposure control for the image.

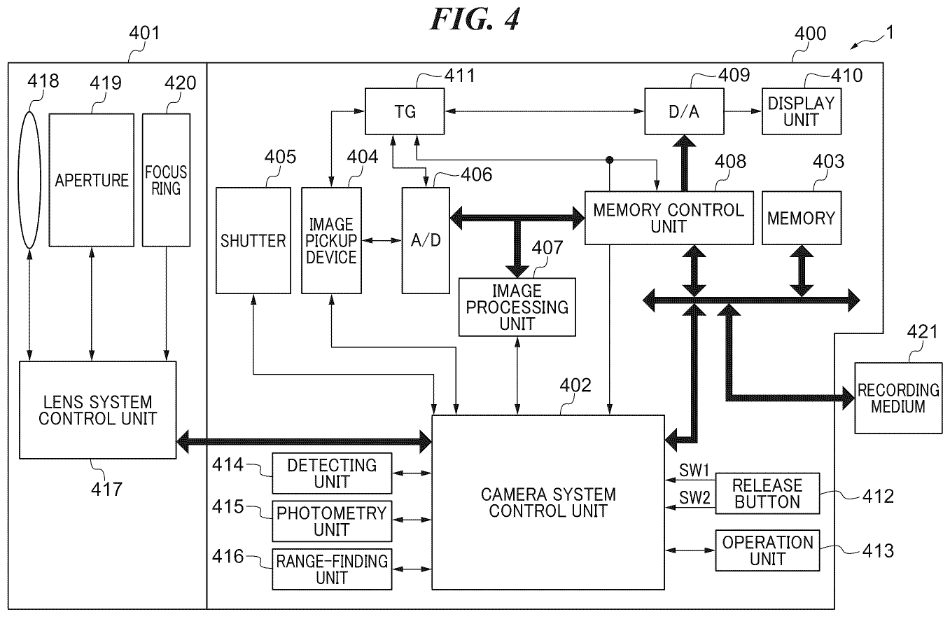

A first embodiment of the present disclosure will be described. FIG. 4 is a block diagram that illustrates a hardware configuration of a camera 1 as an image pickup apparatus according to the first embodiment of the present disclosure. It should be noted that the camera 1 is configured to include a camera main body 400 and a lens unit 401 that is capable of being detached from the camera main body 400. The configuration of the camera 1 in a state where the lens unit 401 has been attached to the camera main body 400 will be described below with reference to FIG. 4.

The camera main body 400 includes a camera system control unit 402, a memory 403, an image pickup device 404, a shutter 405, an A/D conversion unit 406, an image processing unit 407, a memory control unit 408, a D/A conversion unit 409, and a display unit 410. Furthermore, the camera main body 400 includes a timing generator (hereinafter, referred to as “a TG”) 411, a release button 412, an operation unit 413, a detecting unit 414, a photometry unit 415, and a range-finding unit 416.

In addition, the lens unit 401 includes a lens system control unit 417, a photographing lens group 418, an aperture 419, and a focus ring 420.

The camera system control unit 402 is a control unit that controls the respective units of the camera main body 400 in an integrated manner. The memory 403 is a memory configured to include a random-access memory (a RAM) and a read-only memory (a ROM) that have been connected to the camera system control unit 402. The image pickup device 404 (an image sensor) is a charge-coupled device (CCD) image sensor or a complementary metal oxide semiconductor (CMOS) image sensor, and performs photoelectric conversion on a light beam incident via the lens unit 401 (an optical image of a subject incident via the lens unit 401) to output analog image data (a captured image). The driving of the shutter 405 is controlled by a signal from the camera system control unit 402. The shutter 405 is controlled to switch between a light-shielding state, in which the image pickup device 404 is shielded from the light beam incident via the lens unit 401, and a retracted state, in which the optical image of the subject incident via the lens unit 401 is guided to the image pickup device 404.

The A/D conversion unit 406 is a conversion means for converting the analog image data output from the image pickup device 404 into digital image data, and the converted digital image data is recorded in the memory 403. The image processing unit 407 performs predetermined image interpolation, a resizing processing such as reduction, a color conversion processing, and a calculation processing of the number of inaccurate pixel data such as saturated pixels and black-out pixels with respect to the data from the A/D conversion unit 406 or the data from the memory control unit 408. The D/A conversion unit 409 is a conversion means for converting the digital image data recorded in the memory 403 into analog image data for display. The display unit 410 is a display means configured to include a thin-film transistor-driven liquid crystal display (a TFT-LCD) and the like, and is capable of displaying the analog image data for display. The display unit 410 is also capable of performing live view display by sequentially displaying the analog image data output from the D/A conversion unit 409. It should be noted that the display unit 410 is also capable of displaying various kinds of information other than the obtained image data. In addition, the display control of the display unit 410 is performed by, for example, the camera system control unit 402 (a display control unit) controlling the memory 403, the memory control unit 408, an image rendering unit (not shown), and the like. The image rendering unit (not shown) generates superimposed image data by superimposing various kinds of information such as icons on image data obtained from, for example, the memory 403, the image pickup device 404, or the image processing unit 407. The camera system control unit 402 controls the display unit 410 to display the superimposed image data that has been generated, thereby making it possible to perform the live view display or image display, on which various kinds of information have been superimposed, by the display unit 410.

The TG 411 is a timing generating means that transmits timings related to operations within the camera 1 to the respective units of the camera 1, such as a timing of exposure of the image pickup device 404, a timing of changing in frame rate, and a timing of switching between the light-shielding state and the retracted state by the shutter 405.

The release button 412 and the operation unit 413 are operation means for inputting various kinds of operation instructions to the camera system control unit 402. The release button 412 is an instruction means for instructing the start of an image pickup preparation operation and an image pickup operation. When the user performs a change operation to make the release button 412 to entering an SW1 state (here, referred to as “a half-pressing operation”), an instruction to start the image pickup preparation operation is issued, and a range-finding calculation processing, a photometry calculation processing, and the like are started. In addition, when the user performs a change operation to make the release button 412 to entering an SW2 state (here, referred to as “a full-pressing operation”), an instruction to start the image pickup operation is issued, and a series of processes from capturing an image of the subject to obtaining the image are started. The operation unit 413 is a group of input devices including operation members that allow the user to issue various kinds of instructions and perform various kinds of settings with respect to the camera main body 400, such as switches, buttons, and dials. For example, the operation unit 413 includes a power switch, a menu button, and direction indication buttons. It should be noted that in the first embodiment, the display unit 410 is a touch panel display in which a TFT-LCD and a capacitive touch panel are integrated, and the user is able to input information in the same way as when operating the operation unit 413 by operating a user interface (a UI) displayed on the display unit 410.

The detecting unit 414 (a detecting unit) uses the image data obtained from the image processing unit 407 to perform a processing of detecting a specific subject (a detection processing for a specific subject). The photometry unit 415 (a calculating unit) uses the image data obtained from the image processing unit 407 to perform the calculation of a photometric value that provides proper exposure for the detected subject, which serves as information about the luminance of the detected subject. The range-finding unit 416 uses the image data obtained from the image processing unit 407 to perform a range-finding calculation.

It should be noted that the detecting unit 414, the photometry unit 415, and the range-finding unit 416 that have been described above may be configured to be provided integrally with the camera system control unit 402. In this case, the camera system control unit 402 executes various kinds of calculations that are performed by the detecting unit 414, the range-finding unit 416, and the photometry unit 415 that have been described above.

The lens system control unit 417 is a control unit that comprehensively controls the operation of the lens unit 401. It should be noted that in the state where the lens unit 401 has been attached to the camera main body 400, the lens system control unit 417 and the camera system control unit 402 are capable of communicating with each other via an interface (not shown). For example, in response to an instruction from the camera system control unit 402, information about the lens unit 401 that has been attached to the camera main body 400 is output to the camera system control unit 402.

The photographing lens group 418 is a lens group configured with a plurality of lenses including an optical axis shift lens, a zoom lens, a focus lens, and the like. The aperture 419 (a diaphragm) is a light amount adjusting member for adjusting the light amount of a light beam that has passed through the inside of the photographing lens group 418, and the driving of the aperture 419 (the diaphragm) is controlled by the lens system control unit 417. It should be noted that a configuration may be adopted in which the lens system control unit 417 is not provided in the lens unit 401. In the case of adopting this configuration, the operations of the photographing lens group 418 and the aperture 419 are controlled by instructions from the camera system control unit 402.

The focus ring 420 (a changing member) is a ring provided on the outer periphery of the lens unit 401, and is a member that adjusts the position of the photographing lens group 418 in response to a rotation operation of the focus ring 420 performed by the user (hereinafter, referred to as “a user operation”) to change the in-focus position. When the amount of rotation (the rotation amount) of the focus ring 420 due to this rotation operation is inputted into the lens system control unit 417, the lens system control unit 417 performs the position adjustment control of the photographing lens group 418 in accordance with the rotation amount. Hereinafter, the rotation operation of the focus ring 420, which is an operation of changing the in-focus position performed by the user, will be referred to as “a manual focus operation (an MF operation)”.

The camera 1 may further be provided with a recording medium 421 such as a memory card or a hard disk, which is capable of recording the image data recorded in the memory 403. Here, the recording medium 421 may be, for example, a memory card that is a recording medium that is capable of being inserted into or removed from the camera main body 400, but is not limited to this. For example, the recording medium 421 may be an optical disk such as a DVD-RW disk or a magnetic disk such as a hard disk. Furthermore, the recording medium 421 may not be removable, but may be configured to be built into the camera main body 400 in advance.

The above is the basic configuration of the camera 1 according to the first embodiment.

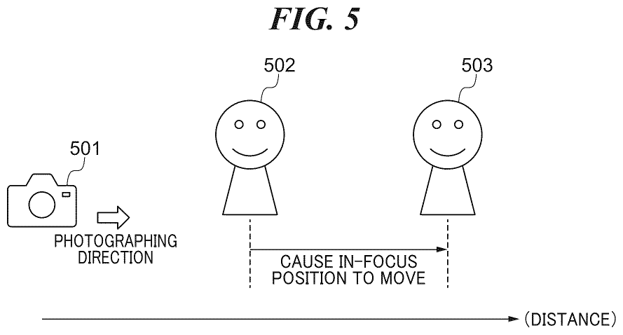

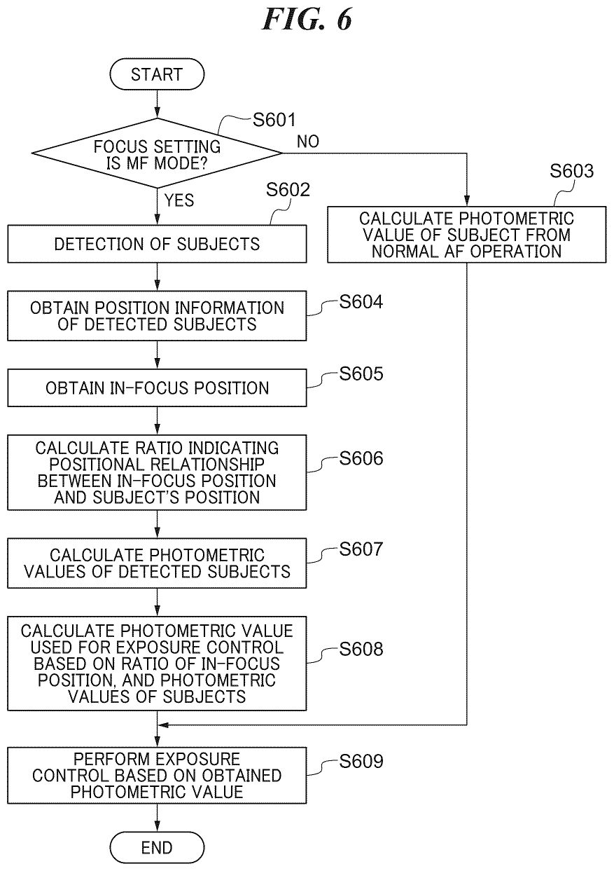

Hereinafter, an exposure control processing according to the first embodiment will be described with reference to FIG. 5 and a flowchart shown in FIG. 6. The exposure control processing according to the first embodiment is executed by the camera system control unit 402 loading a program stored in the ROM included in the memory 403 into the RAM included in the memory 403.

FIG. 5 is a diagram that illustrates a photographing scene assumed in the first embodiment.

In the photographing scene shown in FIG. 5, a person 502 and a person 503 are present within the angle of view of the camera 1, and when viewed from a position 501 where the camera 1 is placed, the person 502 is on the front side (on the near side) and the person 503 is on the deep side (on the far side). In other words, a situation is assumed in which there is a difference between the in-focus position of the person 502 and the in-focus position of the person 503. It should be noted that in FIG. 5, an example is given of a case where subjects to be photographed (subjects that are photographing targets) are persons, but other subjects such as animals or vehicles may also be photographing targets.

As a photographing method, a case is assumed in which the user records and photographs while moving the current in-focus position from the person 502 on the front side toward the person 503 on the deep side by performing an MF operation. However, moving the in-focus position during recording and photographing may be performed in the opposite direction, that is, the current in-focus position may be moved from the person 503 on the deep side toward the person 502 on the front side. It should be noted that the first embodiment, and other embodiments that will be described below are not limited to the case where the user records and photographs as long as the user is able to visually recognize frame images that have been captured periodically, and may be a case where, for example, a live view has been displayed in a photographing standby state.

FIG. 6 is the flowchart of the exposure control processing according to the first embodiment. It should be noted that the exposure control processing according to the first embodiment starts when the user has performed the half-pressing operation of the release button 412.

As shown in FIG. 6, first, in a step S601, it is determined whether a focus setting is a manual focus mode (an MF mode) or an auto focus mode (an AF mode). In the case of being determined that the focus setting is the MF mode (YES in the step S601), the processing proceeds to a step S602, and on the other hand, in the case of being determined that the focus setting is the AF mode (NO in the step S601), the processing proceeds to a step S603.

In the case of proceeding to the step S603, a normal auto focus operation (a normal AF operation) is performed. Here, the person 502 that is within the angle of view and is closest to the camera 1 is detected by the detecting unit 414 as a subject to be targeted by AF, and after the in-focus position is moved to the position of the person 502, the calculation of a photometric value is performed. Then, the processing proceeds to a step S609. On the other hand, in the case of proceeding to the step S602, the detection of the person 502 and the person 503 that are within the angle of view is performed by the detecting unit 414. Then, the processing proceeds to a step S604.

In the step S604, position information of the person 502 that has been detected in the step S602 and position information of the person 503 that has been detected in the step S602 (hereinafter, referred to as “respective position information of the person 502 and the person 503”) are obtained. In the first embodiment, from focus information (information corresponding to the positions of the subjects) obtained from the range-finding unit 416 (a subject position obtaining unit), distances of the person 502 and the person 503 relative to the camera 1 located at the position 501 are obtained as the respective position information of the person 502 and the person 503, but the present disclosure is not limited to this. For example, the distances of the person 502 and the person 503 relative to the camera 1 may be obtained as the respective position information of the person 502 and the person 503, from time-of-flight (ToF) information using an infrared light source and an infrared sensor.

Next, the processing proceeds to a step S605, where the current in-focus position is obtained. The current in-focus position may be any information that indicates the positional relationship between the in-focus position moved by the MF operation at that time point, and the person 502 and the person 503, and is capable of being calculated, for example, based on the rotation amount of the focus ring 420 provided on the lens unit 401.

Next, the processing proceeds to a step S606, where a ratio x indicating the positional relationship between the current in-focus position, and the person 502 and the person 503 is obtained based on the respective position information of the person 502 and the person 503 that have been obtained in the step S604, and the current in-focus position that has been obtained in the step S605. For example, in the case where the person 502 is located 1.0-meter away from the position 501 of the camera 1, the person 503 is located 1.5-meter away from the position 501 of the camera 1, and the current in-focus position is located A-meter away from the position 501 of the camera 1, the ratio (percentage) X % is capable of being obtained based on the following Expression 1.

$$x = 100 * \frac{A - 1.}{1.5 - 1.} \qquad [ Expression 1 ]$$

Next, the processing proceeds to a step S607, where photometry is performed by the photometry unit 415 with respect to the person 502 and the person 503 that have been detected in the step S602, and a first photometric value M1 at which the person 502 has proper exposure and a second photometric value M2 at which the person 503 has proper exposure are obtained.

Next, the processing proceeds to a step S608, where a third photometric value M3 is obtained based on the first photometric value M1, the second photometric value M2, and the ratio of the current in-focus position. The third photometric value M3 is capable of being obtained based on the following Expression 2.

$${M}_{3} = {M}_{1} + ( {M}_{2} - {M}_{1} ) \times ( \frac{x}{100} ) \qquad [ Expression 2 ]$$

According to the above Expression 2, the third photometric value M3 is capable of being changed from the first photometric value M1 of the person 502 to the second photometric value M2 of the person 503 as the in-focus position moves from the person 502 to the person 503 by the MF operation. It should be noted that if the ratio X % becomes greater than 100%, the photometric value will deviate from the second photometric value M2, and the third photometric value M3 will become a photometric value that does not match either the first photometric value M1 or the second photometric value M2. For this reason, in the case where the ratio X that has been calculated based on the above Expression 1 is greater than 100%, the ratio X is set to be 100%. In other words, the value of the third photometric value M3 is set to be the second photometric value M2. Similarly, if the ratio X that has been calculated based on the above Expression 1 becomes smaller than 0%, the third photometric value M3 will become a photometric value that does not match either the first photometric value M1 or the second photometric value M2, so the ratio X is set to be 0%. In other words, the value of the third photometric value M3 is set to be the first photometric value M1.

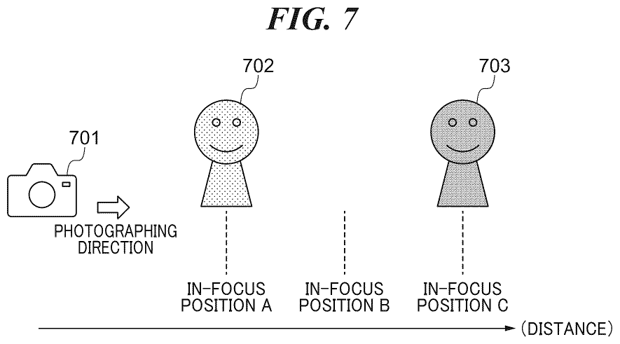

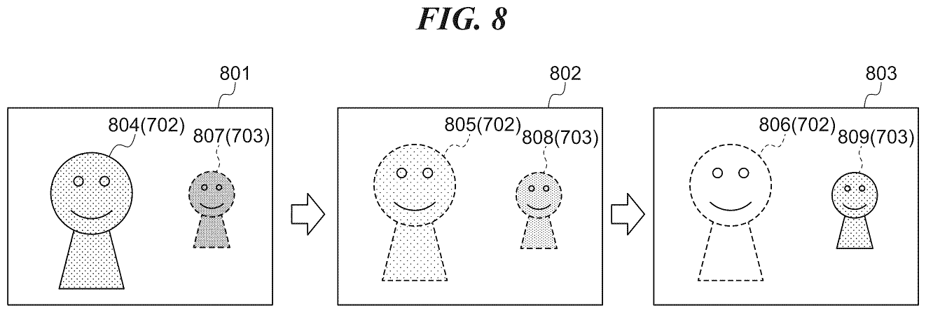

Furthermore, the impression of images to be obtained when recording and photographing while moving the in-focus position by the MF operation will be described with reference to FIG. 7 and FIG. 8. FIG. 7 is a diagram that illustrates the positional relationship between a position 701 of the camera 1, and a person 702 (an in-focus position A) and a person 703 (an in-focus position C) who are within the angle of view, and the current in-focus position by the MF operation, in the photographing scene of FIG. 5. Here, a scene will be described in which the in-focus position by the MF operation moves from the in-focus position A at the start of movement, through an in-focus position B, and to the in-focus position C at the end of movement. In addition, this photographing scene is a scene in which the person 703 becomes a dark subject compared to the person 702.

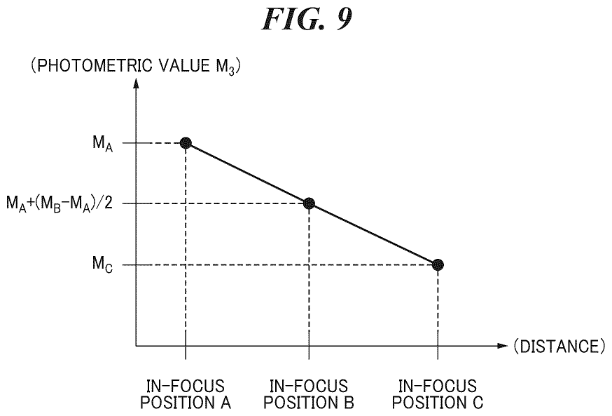

FIG. 8 shows images 801 to 803 to be recorded and photographed during the MF operation in this photographing scene, and the relationship between the third photometric value M3 and the in-focus position is shown in a graph of FIG. 9.

In the images 801 to 803 that are shown in FIG. 8, as indicated in parentheses, images 804, 805, and 806 of persons on the left side correspond to the person 702 shown in FIG. 7, and images 807, 808, and 809 of persons on the right side correspond to the person 703 shown in FIG. 7.

In other words, the image 801 is an image corresponding to the in-focus position A (an image in which the exposure control is performed based on a photometric value MA, which is the result of performing the photometry of the image 804 of the person 702). The image 803 is an image corresponding to the in-focus position C (an image in which the exposure control is performed based on a photometric value MB, which is the result of performing the photometry of the image 809 of the person 703). The image 802 is an image corresponding to the in-focus position B (an image in which the exposure control is performed based on the third photometric value M3 obtained by inputting the photometric value MA as the first photometric value M1 and the photometric value MB as the second photometric value M2 into the above Expression 2).

FIG. 9 is the graph that shows a change in the third photometric value M3 during the MF operation in the photographing scene of FIG. 5.

In the image 801 to be first recorded and photographed, the in-focus position is located at the position of the person 702 on the front side (at the in-focus position A). As shown in the graph of FIG. 9, the third photometric value M3 at this time becomes the photometric value MA. In other words, since the exposure is controlled based on the photometry result of the person 702, the image 804 of the person 702 has an appropriate brightness.

In the image 802 to be then recorded and photographed, the in-focus position is located at a position (a midpoint) between the person 702 and the person 703 (at the in-focus position B). As shown in the graph of FIG. 9, the third photometric value M3 at this time becomes MA+ (MB-MA)/2. This formula is a calculation formula when the ratio X of the current in-focus position is set to be X=50 according to the above Expression 2. The third photometric value M3 at this time becomes an intermediate value between the person 702 and the person 703, and therefore the photometric value is smaller than MA at the in-focus position A. Therefore, the exposure changes to be brighter, and the image 808 of the person 703 within the image 802 approaches an appropriate brightness.

In the image 803 to be recorded and photographed last, the in-focus position is moved to the position of the person 703 on the deep side (to the in-focus position C). As shown in the graph of FIG. 9, the third photometric value M3 at this time becomes the photometric value MB. In other words, since the exposure is controlled based on the photometry result of the person 703 on the deep side, the image 809 of the person 703 has an appropriate brightness.

In this method, the final photometric value M3 is obtained based on the positional relationship between the positions of the person 702 and the person 703 in FIG. 7, and the in-focus position moved by the MF operation. Therefore, in the case where the user has performed the MF operation at a low speed, the exposure is capable of being changed at a low speed, and in the case where the user has performed the MF operation at a high speed, the exposure is capable of being changed at a high speed.

As described above, according to the first embodiment, when the focus is moved from a first subject to a second subject by an MF operation, the third photometric value M3 is obtained from the first photometric value M1 for the first subject and the second photometric value M2 for the second subject based on the position and the in-focus position of each subject. As a result, even in the case where the ring operation has been performed at a low speed with the MF operation, it is possible to perform natural exposure tracking that matches the focus.

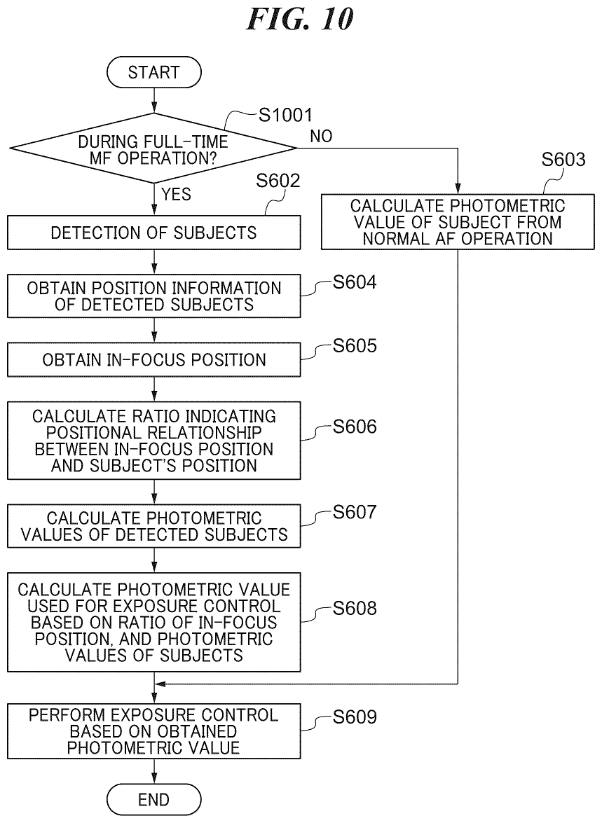

A second embodiment of the present disclosure will be described. Hereinafter, an exposure control processing according to the second embodiment of the present disclosure will be described with reference to a flowchart shown in FIG. 10. It should be noted that in the second embodiment, the same configurations (components) as those in the first embodiment are denoted by the same reference numerals, and duplicate descriptions will be omitted.

In the second embodiment, as the focus setting, the user is able to select from the auto focus mode (the AF mode), the manual focus mode (the MF mode), and a hybrid mode (a first mode) that is the AF mode but also allows the user to perform a manual operation. Hereinafter, this hybrid mode will be referred to as “a full-time MF mode” for convenience. The full-time MF mode normally performs an AF operation, but when the user has performed an MF operation, such as when the user has operated the focus ring 420, the camera stops the AF operation and changes the in-focus position in accordance with the operation amount of the focus ring 420.

The exposure control processing in the second embodiment is as shown in the flowchart of FIG. 10. The difference between the flowchart of FIG. 10, and the flowchart of FIG. 6 in the first embodiment is that a step S1001 is included instead of the step S601. Therefore, the step S1001 will be described below. It should be noted that in FIG. 10, the same steps as those in FIG. 6 are denoted by the same reference numerals, and duplicate descriptions will be omitted.

In the step S1001, it is determined whether or not the selected focus mode is the full-time MF mode and it is during a manual operation. Here, in the case of being determined that no manual operation has been performed for a certain threshold time or longer and it is not during a manual operation, the processes of the step S603 and subsequent steps are performed, and otherwise, it is determined that it is during a manual operation, and the processes of the step S602 and subsequent steps are performed. This is to stabilize the determination result, which will change sensitively since if the determination is made strictly based only on the latest state.

In other words, in the case where it is not during a manual operation, the processing proceeds to the step S603, where a normal AF operation is performed and the calculation of a photometric value is performed according to the subject to be targeted by AF. On the other hand, in the case where it is during a manual operation, the processing proceeds to the step S602, and the processes of the step S602 and subsequent steps S604 to S609 are performed.

As described above, according to the second embodiment, in the case where the focus setting of the camera 1 is the full-time MF mode, it is possible to obtain the same effects as those of the first embodiment, even in the case where the ring operation has been performed at a low speed with the MF operation, it is possible to perform natural exposure tracking that matches the focus.

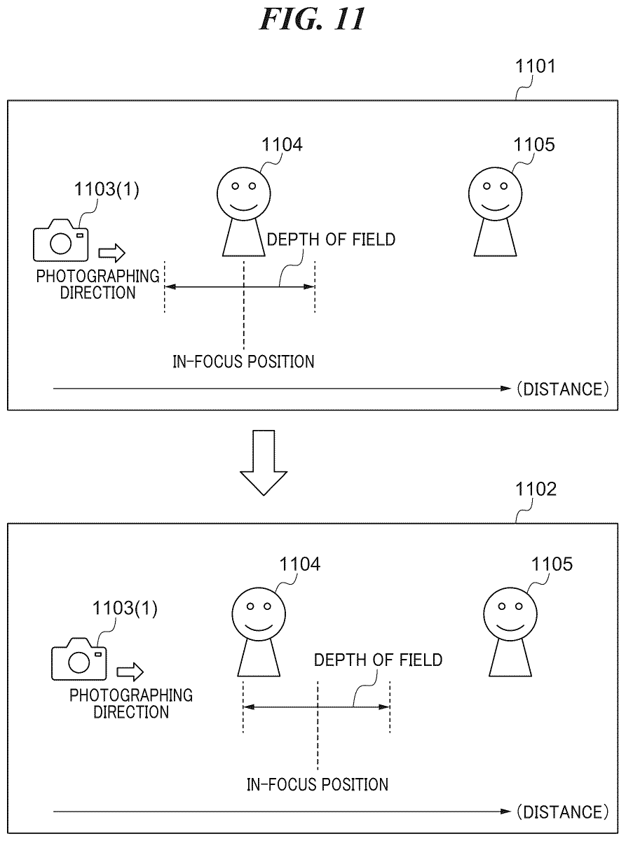

A third embodiment of the present disclosure will be described. Hereinafter, an exposure control processing according to the third embodiment of the present disclosure will be described with reference to FIGS. 11 to 14. It should be noted that in the third embodiment, the same configurations (components) as those in the first embodiment are denoted by the same reference numerals, and duplicate descriptions will be omitted.

In the third embodiment, a case is assumed in which the depth of field is deep due to the setting of the aperture 419 of the lens unit 401 performed by the user. The depth of field refers to a range which is in focus with respect to the optical axis, and the more the aperture 419 is opened, the shallower the depth of field becomes, and the more the aperture 419 is closed, the deeper the depth of field becomes. In other words, in a state where the in-focus position coincides with the subject, if the depth of field is shallow, only the subject will appear to be in focus, and if the depth of field is deep, a certain range in front of and behind the subject will appear to be in focus.

FIG. 11 shows the camera 1, a person 1104 and a person 1105 that are subjects, the in-focus position, and the depth of field, in a photographing scene with a deep depth of field assumed in the third embodiment.

A state 1101 shown in FIG. 11 indicates a state in which the position of the person 1104 on the front side with respect to the camera 1 located at a position 1103 coincides with the in-focus position, and a state 1102 shown in FIG. 11 indicates a state in which the in-focus position has been moved from the state 1101 to the deep side with respect to the camera 1.

Since the position of the person 1104 coincides with the in-focus position, the state 1101 shown in FIG. 11 is a state in which the person 1104 is in focus. However, in the case where the depth of field is deep like this, the person 1104 will be in focus as long as the person 1104 is within the depth of field even if the person 1104 does not coincide with the in-focus position. In other words, even in the case where the in-focus position has been moved from the position of the person 1104 to the deep side with respect to the camera 1, if the person 1104 is within the depth of field as in the state 1102, the person 1104 will continue to be in focus.

Here, in the first embodiment and the second embodiment, in a scene in which the in-focus position is moved from the state 1101 to the state 1102, when moving the in-focus position with the MF operation from the state 1101, in which the person 1104 is in focus, starts, the third photometric value M3 begins to change. In addition, in accordance with the change in the third photometric value M3, a fluctuation in exposure also begins. However, even in the case where moving the in-focus position with the MF operation starts, it is desirable to perform the exposure control by using a photometric value that matches the person 1104 as long as the person 1104 is within the depth of field and is in focus.

In the case where the depth of field is shallow, since the person 1104 will go out of focus and begin to become blurred as soon as moving the in-focus position with the MF operation starts, there will be no issue even if the exposure fluctuates from the time point when moving the in-focus position has started. However, in the case where the depth of field is deep, even if moving the in-focus position with the MF operation starts, the person 1104 will remain in focus until the person 1104 moves out of the depth of field. Therefore, even in a state where the person 1104 is still in focus as the state 1102, the exposure changes, which becomes an issue. It should be noted that this issue occurs not only in the case where the in-focus position is near the person 1104, but also in the case where the in-focus position is near the person 1105.

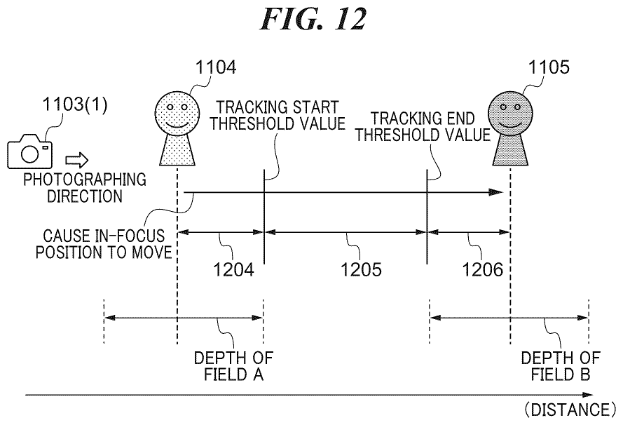

In the third embodiment, in order to deal with the above issue, as shown in FIG. 12, a tracking start threshold value and a tracking end threshold value are provided between the person 1104 and the person 1105. The tracking start threshold value represents a distance at which tracking of the exposure starts during a period in which the in-focus position is moved from the position of the person 1104 to the position of the person 1105, and a standard for the distance is the position of the person 1104. The tracking end threshold value represents a distance at which tracking of the exposure ends during the period in which the in-focus position is moved from the position of the person 1104 to the position of the person 1105, and a standard for the distance is the position of the person 1105.

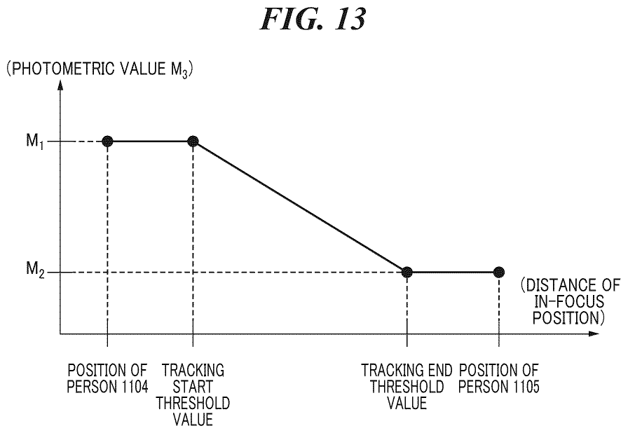

The tracking start threshold value and the tracking end threshold value will be described with reference to FIG. 12 and FIG. 13.

FIG. 12 shows the positional relationship between the camera 1, the person 1104, the person 1105, the in-focus position, the tracking start threshold value, and the tracking end threshold value, in the case where the in-focus position is moved from the position of the person 1104 on the front side with respect to the camera 1 located at the position 1103 to the position of the person 1105 on the deep side with respect to the camera 1 located at the position 1103.

Here, it is assumed that in the case where the photometric value of the person 1104 is set to M1 and the photometric value of the person 1105 is set to M2, M1>M2 holds. Although the in-focus position is moved from the position of the person 1104 to the position of the person 1105 by the MF operation performed by the user, in the case where the in-focus position is between the position of the person 1104 and the tracking start threshold value (the in-focus position is located in a section 1204), the photometric value M1 of the person 1104 is set to be a third photometric value M′3 to be used for exposure control.

In addition, in the case where the in-focus position is between the tracking start threshold value and the tracking end threshold value (the in-focus position is located in a section 1205), first, a ratio X′ % of the in-focus position with respect to the positions of the tracking start threshold value and the tracking end threshold value is obtained as follows.

For example, in the case where the tracking start threshold value is located 1.2-meter away from the camera 1, the tracking end threshold value is located 1.4-meter away from the camera 1, and the current in-focus position is located B-meter away from the camera 1, the ratio (percentage) X′ % is capable of being obtained based on the following Expression 3.

$${x}^{′} = 100 * \frac{B - 1.2}{1.4 - 1.2} \qquad [ Expression 3 ]$$

Next, the third photometric value M′3 is obtained based on the ratio X′ %, the photometric value M1 of the person 1104, and the photometric value M2 of the person 1105, by using the following Expression 4, and is used for exposure control.

$${M}_{3}^{′} = {M}_{1} + ( {M}_{2} - {M}_{1} ) \times ( \frac{{x}^{′}}{100} ) \qquad [ Expression 4 ]$$

In the case where the in-focus position is between the tracking end threshold value and the position of the person 1105 (the in-focus position is located in a section 1206), the photometric value M2 of the person 1105 is set to be the third photometric value M′3 to be used for exposure control.

In other words, in the case where the in-focus position is being moved between the person 1104 and the tracking start threshold value (the section 1204) and between the tracking end threshold value and the person 1105 (the section 1206), the photometric value to be used for exposure control is controlled not to change. It should be noted that a depth of field A shown in FIG. 12 represents the depth of field when the in-focus position has been adjusted to match the position of the person 1104, and a depth of field B shown in FIG. 12 represents the depth of field when the in-focus position has been adjusted to match the position of the person 1105. It is desirable to match the tracking start threshold value and the tracking end threshold value, the depth of field when the in-focus position has been adjusted to match each subject as shown in FIG. 12.

A graph of FIG. 13 shows the relationship between the distance of the in-focus position and the third photometric value M′3, in FIG. 12. As shown in the graph of FIG. 13, first, while the in-focus position is in the section from the person 1104 to the tracking start threshold value, the third photometric value M′3 to be used for exposure control is the photometric value M1 of the person 1104 and is constant. Next, while the in-focus position is in the section from the tracking start threshold value to the tracking end threshold value, the third photometric value M′3 to be used for exposure control changes from the photometric value M1 of the person 1104 to the photometric value M2 of the person 1105. Finally, while the in-focus position is in the section from the tracking end threshold value to the person 1105, the third photometric value M′3 to be used for exposure control is the photometric value M2 of the person 1105 and is constant.

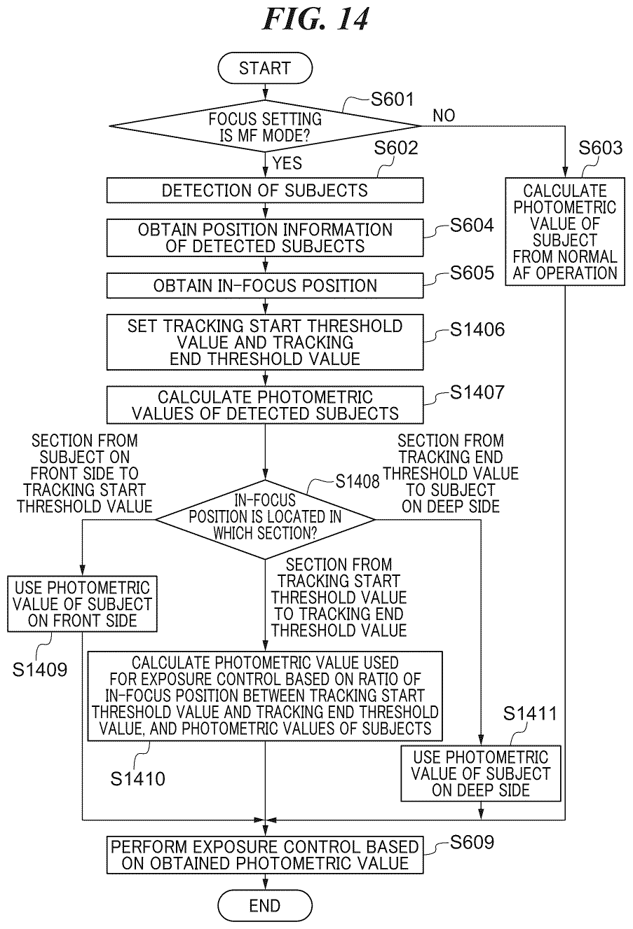

FIG. 14 is a flowchart of an exposure control processing according to the third embodiment. The difference between the flowchart of FIG. 14, and the flowchart of FIG. 6 in the first embodiment is that steps S1406 to S1411 are included instead of the steps S606 to S608. Therefore, the steps S1406 to S1411 will be described below. It should be noted that in FIG. 14, the same steps as those in FIG. 6 are denoted by the same reference numerals, and duplicate descriptions will be omitted.

As shown in FIG. 14, first, the processes of the steps S601 to S605 are executed in the same manner as in the flowchart of FIG. 6.

After the step S605, the processing proceeds to the step S1406, where a tracking start threshold value and a tracking end threshold value are set by a setting unit. Here, the tracking start threshold value and the tracking end threshold value are calculated in accordance with the respective positions of the person 1104 and the person 1105, and the depth of field. Furthermore, the respective values of the tracking start threshold value and the tracking end threshold value may be configured to be capable of being manually adjusted by the user, or may be automatically adjusted by the camera system control unit 402.

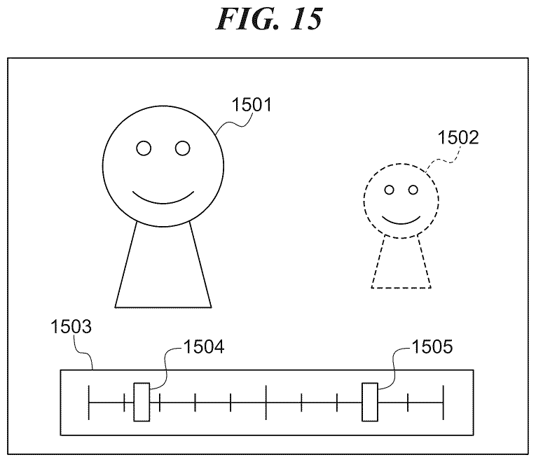

A screen example in the case where the user is able to manually adjust the respective values of the tracking start threshold value and the tracking end threshold value will be described with reference to FIG. 15. FIG. 15 shows a live view screen before photographing, which is displayed on the display unit 410.

A number line 1503 at the bottom of the screen shown in FIG. 15 is provided with an adjustment bar 1504 (a first icon) for adjusting the tracking start threshold value and an adjustment bar 1505 (a second icon) for adjusting the tracking end threshold value. The positions of the adjustment bar 1504 and the adjustment bar 1505 represent the relative positions of the tracking start threshold value and the tracking end threshold value with respect to the camera 1. In addition, the left and right ends of the number line 1503 represent a relative position 1501 of the person 1104 with respect to the camera 1 and a relative position 1502 of the person 1105 with respect to the camera 1. The user is able to manually perform the adjustment of the tracking start threshold value and the tracking end threshold value by performing user operations such as drag operations of the adjustment bar 1504 and the adjustment bar 1505 that are provided on the number line 1503.

Next, an example of a case, in which the camera system control unit 402 automatically adjusts the respective values of the tracking start threshold value and the tracking end threshold value, will be described. In the case where the camera system control unit 402 automatically adjusts the respective values of the tracking start threshold value and the tracking end threshold value, for example, the threshold values may be adjusted in accordance with an absolute value (=|M1−M2|) of the difference between the photometric value of the subject on the front side and the photometric value of the subject on the deep side. In the case where the absolute value of the difference between the photometric value of the subject on the front side and the photometric value of the subject on the deep side is large, since the exposure fluctuation amount when the in-focus position has been moved increases, if the section from the tracking start threshold value to the tracking end threshold value becomes short, the exposure fluctuation speed will tend to become rapid. Here, if the exposure fluctuation becomes steep, it may be perceived as exposure flickering during moving image photographing (video photographing). Therefore, in order to alleviate this issue, an automatic adjustment method may be considered in which the larger the difference between the photometric value of the subject on the front side and the photometric value of the subject on the deep side, the longer the section from the tracking start threshold value to the tracking end threshold value.

Returning to FIG. 14, next, the processing proceeds to the step S1407, where the photometric values of the subjects (the person 1104 and the person 1105 in this example) that have been detected in the step S602 are calculated. This is similar to the step S607 in FIG. 6 of the first embodiment.

Next, the processing proceeds to the step S1408, where it is determined in which section the in-focus position is located. The sections classified here are the three sections 1204 to 1206 shown in FIG. 12, namely, the section from the subject on the front side with respect to the camera 1 to the tracking start threshold value, the section from the tracking start threshold value to the tracking end threshold value, and the section from the tracking end threshold value to the subject on the deep side with respect to the camera 1. In the case of being determined that the in-focus position is located in the section from the subject on the front side to the tracking start threshold value, the processing proceeds to the step S1409, where the photometric value of the subject on the front side is used for exposure control performed in the subsequent step S609. In the case of being determined that the in-focus position is located in the section from the tracking start threshold value to the tracking end threshold value, the processing proceeds to the step S1410, where first, the ratio X′ % of the in-focus position between the tracking start threshold value and the tracking end threshold value is calculated by using the above Expression 3. Next, by using the above Expression 4, the photometric value to be used for exposure control performed in the subsequent step S609 is calculated based on the calculated ratio X′ %, and the photometric value of the subject on the front side and the photometric value of the subject on the deep side. In other words, in the case where the tracking start threshold value is set to 0% and the tracking end threshold value is set to 100%, the ratio (percentage) X′ %, which indicates that the current in-focus position is located at a position of what % (percentage), is obtained. In the case of being determined that the in-focus position is located in the section from the tracking end threshold value to the subject on the deep side, the processing proceeds to the step S1411, where the photometric value of the subject on the deep side is used for exposure control performed in the subsequent step S609. Finally, the processing proceeds to the step S609, where the exposure control is performed based on the obtained photometric value.

As described above, according to the third embodiment, by providing the tracking start threshold value and the tracking end threshold value, it is possible to perform exposure tracking being connected with the focus degree of each subject that becomes the in-focus position at the time of starting the MF operation and at the time of ending the MF operation.

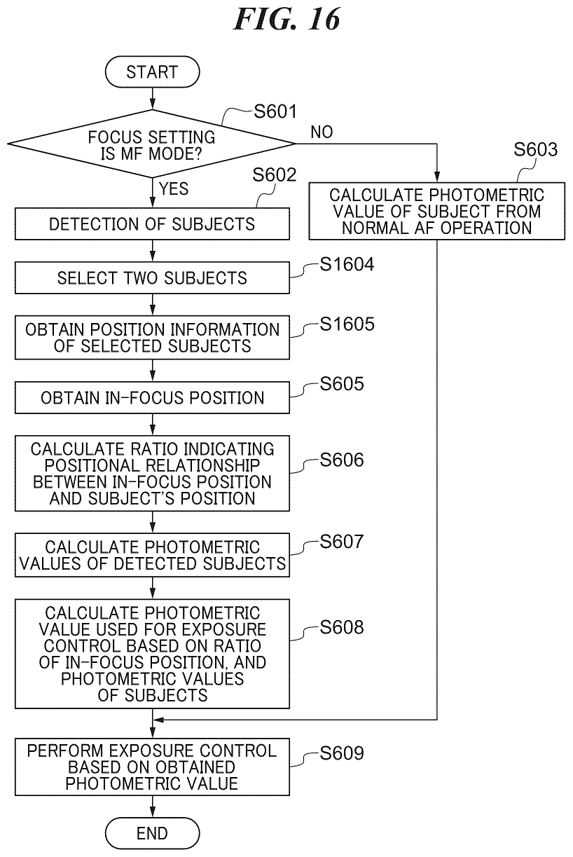

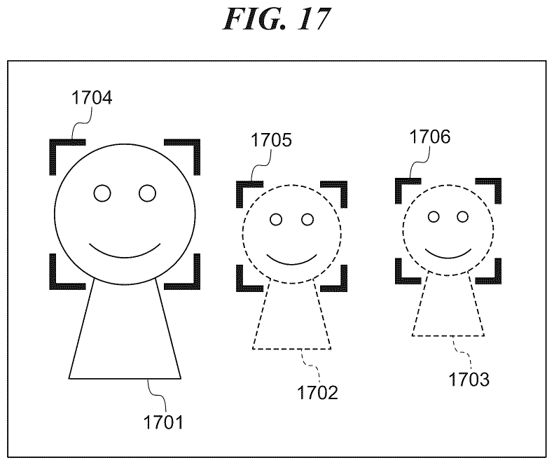

A fourth embodiment of the present disclosure will be described. Hereinafter, an exposure control processing according to the fourth embodiment of the present disclosure will be described with reference to a flowchart shown in FIG. 16, and FIG. 17. It should be noted that in the fourth embodiment, the same configurations (components) as those in the first embodiment are denoted by the same reference numerals, and duplicate descriptions will be omitted.

In the fourth embodiment, a case is assumed in which there are three or more subjects within the angle of view.

The exposure control processing in the fourth embodiment is as shown in the flowchart of FIG. 16. The difference between the flowchart of FIG. 16, and the flowchart of FIG. 6 in the first embodiment is that steps S1604 and S1605 are included instead of the step S604. Therefore, the steps S1604 and S1605 will be described below. It should be noted that in FIG. 16, the same steps as those in FIG. 6 are denoted by the same reference numerals, and duplicate descriptions will be omitted.

As shown in FIG. 16, first, the processes of the steps S601 to S603 are executed in the same manner as in the flowchart of FIG. 6.

After the step S602, the processing proceeds to the step S1604, where two subjects, which are targets, are selected by a selecting unit from among the subjects that have been detected in the step S602. One of the two subjects that have been selected in the step S1604 is designated as a first subject, and the other is designated as a second subject. It should be noted that the selection method for selecting two subjects may be a method in which the user arbitrarily selects two subjects, or a method in which the camera 1 automatically selects two subjects.

A screen example in a case where the user arbitrarily selects two subjects will be described with reference to FIG. 17. FIG. 17 shows a live view screen of a scene in which three subjects have been detected within the angle of view, which is displayed on the display unit 410. In the case where there are three subjects within the angle of view, as shown in FIG. 17, a method of displaying detected persons 1701 to 1703, faces of which, to which user-selectable frames 1704 to 1706 are respectively attached, and allowing the user to select two frames from among the displayed frames 1704 to 1706 may be considered. As the selection method for the user, a method of touch-selecting the frames attached to two subjects that are targets by touch operations on the display unit 410 may be considered. For example, the subject that has been touch-selected first is set to the first subject, and the subject that has been touch-selected later is set to the second subject.

Next, an example in a case where the camera 1 automatically selects two subjects will be described with reference to FIG. 17. As a method for the camera 1 to automatically select two subjects, for example, the subject closest to the current in-focus position in a depth direction (the person 1701 in the example of FIG. 17) is selected as the first subject, and the second subject is selected from the remaining subjects. For example, a method may be considered in which the priorities of the remaining subjects are calculated by using a priority calculation method, in which, for example, the priority of a larger subject in size is given a higher priority, and the priority of a subject closer to the center of the screen is given a higher priority, and the subject with the highest priority among the calculated priorities (the subject with the highest calculated priority) is selected as the second subject. In this case, in FIG. 17, the person 1702 is selected as the second subject.

Returning to FIG. 16, next, the processing proceeds to the step S1605, where position information is obtained for the two subjects that have been selected in the step S1604. The process is the same as that in the step S604 of FIG. 6 of the first embodiment, except that the two subjects, which are targets, are the two subjects that have been selected in the step S1604.

Next, the processes of the step S605 and subsequent steps are executed in the same manner as in the first embodiment.

As described above, according to the fourth embodiment, by being arbitrarily selected by the user or by being automatically selected by the camera 1, two target subjects are selected. As a result, even in the case where there are three or more subjects within the angle of view, it is possible to perform natural exposure tracking in accordance with the movement of the in-focus position with respect to the subject that the user has intended to focus on.

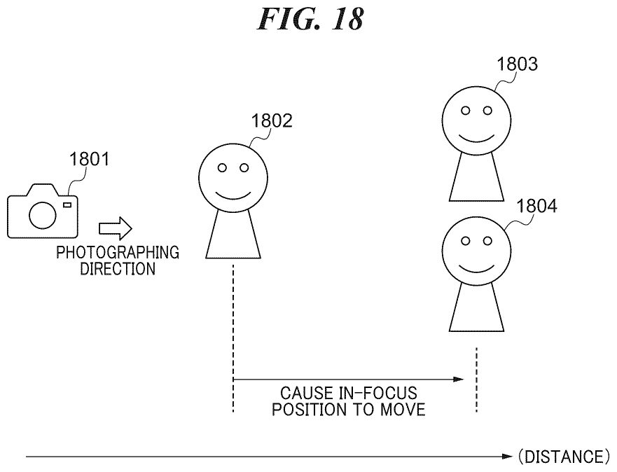

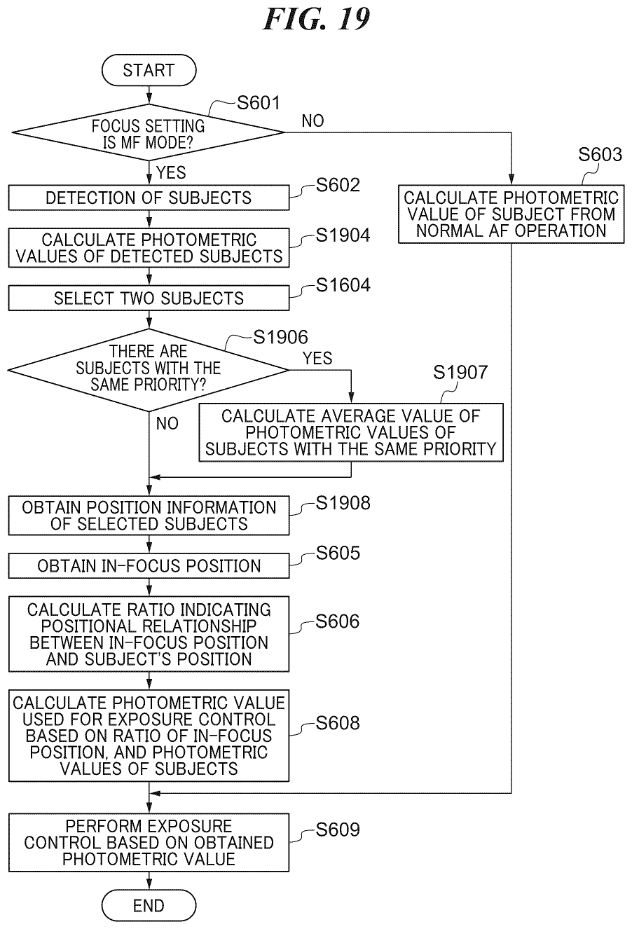

A fifth embodiment of the present disclosure will be described. Hereinafter, an exposure control processing according to the fifth embodiment of the present disclosure will be described with reference to FIG. 18, and a flowchart shown in FIG. 19. It should be noted that in the fifth embodiment, the same configurations (components) as those in the first embodiment are denoted by the same reference numerals, and duplicate descriptions will be omitted.

In the fifth embodiment, similar to the step S1604 in the fourth embodiment, two subjects that are targets are automatically selected by the camera 1. However, in the fifth embodiment, a case is assumed in which a plurality of subjects that are candidates for the second subject have the same priority, that is, a case is assumed in which there are a plurality of subjects with the highest priority among the priorities that have been calculated in the step S1604 (there are a plurality of subjects with the highest priority calculated in the step S1604).

FIG. 18 shows an example of the positional relationship between the camera 1, and three persons 1802 to 1804 who are within the angle of view, in the case where the persons 1803 and 1804, who are subjects that are candidates for the second subject, have the same priority.

As shown in FIG. 18, in a scene where the three persons 1802 to 1804 are within the angle of view of the camera 1, considering the case where the person 1803 and the person 1804 are within the same depth (that is, the case where the distance from the camera 1 to the person 1803 is almost the same as the distance from the camera 1 to the person 1804). In such a scene, when the second subject is automatically selected by the camera 1 in the step S1604 of the fourth embodiment, it is considered that the priority to be used for automatic selection is calculated based on, for example, the proximity (distance) of the subject from the camera 1, and the size of the subject in the obtained image. In this case, the person 1803 and the person 1804 have the same priority, and it becomes impossible to determine which one (which person) should be selected as the second subject.

In order to deal with this issue, in the fifth embodiment, an average value of respective photometric values of the person 1803 and the person 1804 who have the same priority is calculated.

The exposure control processing in the fifth embodiment is as shown in the flowchart of FIG. 19. The difference between the flowchart of FIG. 19, and the flowchart of FIG. 16 in the fourth embodiment is that a step S1904 is provided between the steps S602 and S1604, and steps S1906 and S1907 are provided between the steps S1604 and S1605. It should be noted that in FIG. 19, the same steps as those in FIG. 16 are denoted by the same reference numerals, and duplicate descriptions will be omitted.

As shown in FIG. 19, first, the processes of the steps S601 to S603 are executed in the same manner as in the flowchart of FIG. 16.

After the step S602, the processing proceeds to the step S1904, where photometric values of the subjects that have been detected in the step S602 are calculated. The step S1904 is the same process as the step S607 of FIG. 16 of the fourth embodiment, and only the order of the steps is changed.

Next, the processing proceeds to the step S1604, where the selection of two subjects from the subjects that have been detected in the step S602 is performed. As the selection method, the method of being automatically selected by the camera 1 is assumed.

Next, the processing proceeds to the step S1906, where it is determined whether or not two subjects are capable of being selected in the selection process of the step S1604, that is, it is determined whether or not there are subjects with the same priority when the automatic selection has been performed based on, for example, the size of the subject. In the case of being determined that two subjects are capable of being selected (that is, in the case of being determined that there are no subjects with the same priority), the processing proceeds to a step S1908, and on the other hand, in the case of being determined that two subjects are not capable of being selected (that is, in the case of being determined that there are subjects with the same priority), the processing proceeds to the step S1907.

In the case where it is determined in the step S1906 that two subjects are not capable of being selected and the processing has proceeded to the step S1907, an average value of photometric values of the subjects with the same priority is calculated by an average value calculating unit. The average value of the photometric values, which has been calculated in the step S1907, is used in the calculation as the second photometric value M2 in the later step S608. Then, the processing proceeds to the step S1908.

In the step S1908, position information of the two subjects that have been selected in the step S1604 is obtained. It should be noted that in the case of being determined in the step S1906 that there are subjects with the same priority, since the distances from the camera 1 to the subjects with the same priority are almost the same, the position information of one of the subjects with the same priority is obtained. However, an average value of the position information of the subjects with the same priority may be obtained. Thereafter, the processes of the steps S605 and S606 are executed, and then the processing proceeds to the step S608.

In the step S608, a photometric value to be used for exposure control is calculated based on the photometric values of the subjects, and the ratio of the in-focus position that has been obtained in the step S606. Here, in the step S608 of the first, second and fourth embodiments, and in the step S1410 corresponding to the step S608 of the third embodiment, the photometric value of a single subject is used as the second photometric value M2. On the other hand, in the step S608 of the fifth embodiment, the average value of the photometric values, which has been calculated in the step S1907, may be used as the second photometric value M2.

Finally, the processing proceeds to the step S609, where the exposure control is performed based on the photometric value that has been obtained in the step S608, and then the exposure control processing in the fifth embodiment ends.

As described above, according to the fifth embodiment, as in the fourth embodiment, when selecting two target subjects by automatic selection performed by the camera 1, if a plurality of subjects have the same priority and the two target subjects are not capable of being selected, an average value of photometric values of the subjects with the same priority will be calculated. As a result, in the case where there are three or more subjects within the angle of view, it is possible to perform natural exposure tracking, which takes into account the photometric values of these subjects, when the in-focus position is moved.

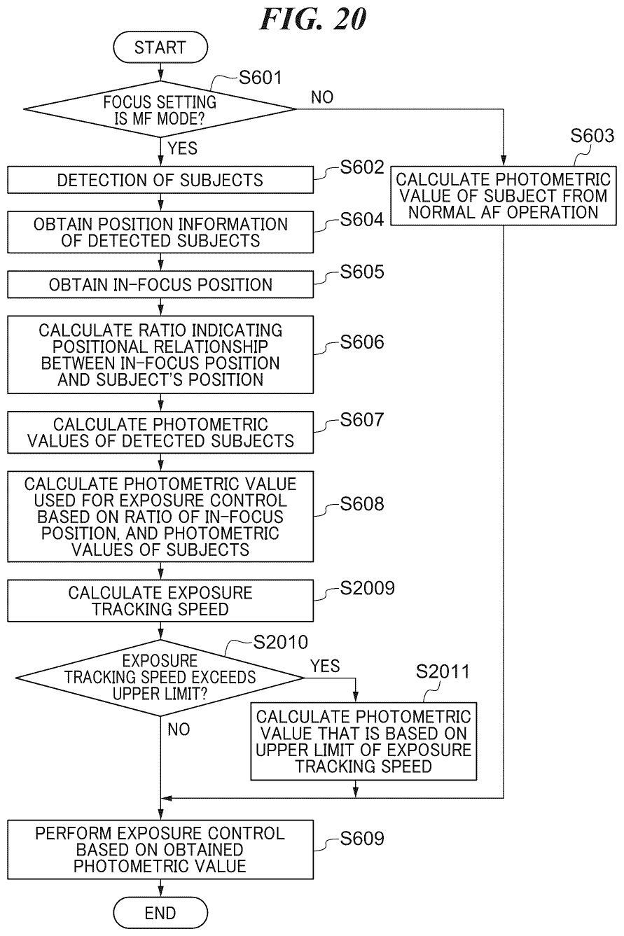

A sixth embodiment of the present disclosure will be described. Hereinafter, an exposure control processing according to the sixth embodiment of the present disclosure will be described with reference to a flowchart shown in FIG. 20. It should be noted that in the sixth embodiment, the same configurations (components) as those in the first embodiment are denoted by the same reference numerals, and duplicate descriptions will be omitted.

In the sixth embodiment, a case is assumed in which regarding exposure tracking when the in-focus position has been moved by the MF operation, the exposure tracking speed is fast, and the exposure fluctuation becomes steep.

In the first embodiment, in the positional relationship shown in FIG. 1, if the difference between the photometric value of the person 102 and the photometric value of the person 103 is large, the exposure fluctuation amount when the in-focus position is moved from the person 102 to the person 103 will become large. In addition, if the distance between the person 102 and the person 103 is close (short), since the time required when the in-focus position is moved from the person 102 to the person 103 will become short, the exposure fluctuation speed will become fast. If such states (situations) are combined, the exposure fluctuation when the movement of the in-focus position has been performed will become steep.

When such a steep exposure fluctuation occurs, the entire screen of the display unit 410 during live view display appears to flicker. This issue becomes an issue in the case where the issue of flickering across the entire screen takes priority over the linkage between the movement of the in-focus position and the exposure fluctuation.

The exposure control processing in the sixth embodiment is as shown in the flowchart of FIG. 20. The difference between the flowchart of FIG. 20, and the flowchart of FIG. 6 in the first embodiment is that steps S2009 to S2011 are provided between the steps S608 and S609. It should be noted that in FIG. 20, the same steps as those in FIG. 6 are denoted by the same reference numerals, and duplicate descriptions will be omitted.

As shown in FIG. 20, first, the processes of the steps S601 to S608 are executed in the same manner as in the flowchart of FIG. 6.

Next, the processing proceeds to the step S2009, where an exposure tracking speed is calculated by a tracking speed calculating unit. The exposure tracking speed is capable of being obtained by, for example, saving (storing), in the memory 403, the photometric value that has been used for exposure control of the previous frame, and calculating the difference between the photometric value of the previous frame and the photometric value of the current frame. In other words, the greater the difference between the photometric value of the previous frame and the photometric value of the current frame, the faster the exposure tracking speed calculated in the step S2009.

Next, the processing proceeds to the step S2010, where it is determined whether or not the exposure tracking speed that has been calculated in the step S2009 exceeds an upper limit value. The upper limit value has been set in advance, and for example, may be a value designated by the user from a menu setting, or may be a value that has been preset in the camera 1. In the case of being determined that the exposure tracking speed does not exceed the upper limit value (NO in the step S2010), the processing proceeds to the step S609, and on the other hand, in the case of being determined that the exposure tracking speed exceeds the upper limit value (YES in the step S2010), the processing proceeds to the step S2011.

In the case where it is determined in the step S2010 that the exposure tracking speed exceeds the upper limit value and the processing has proceeded to the step S2011, a photometric value that is based on the upper limit value of the exposure tracking speed is calculated. For example, in the case where the exposure tracking speed has been calculated based on the difference between the photometric value of the previous frame and the photometric value of the current frame, the photometric value of the current frame is calculated so that the difference between the photometric value of the previous frame and the photometric value of the current frame becomes the upper limit value. Then, the processing proceeds to the step S609.

Finally, the processing proceeds to the step S609, where the exposure control is performed based on the obtained photometric value, and then the exposure control processing in the sixth embodiment ends.

As described above, according to the sixth embodiment, by setting the upper limit to the exposure tracking speed, it is possible to prevent a steep exposure fluctuation while performing natural exposure tracking that matches the focus.

It should be noted that in the above embodiments, the case has been described in which the image pickup apparatus according to the present disclosure is a digital camera for personal use, but the present disclosure is not limited to this case. In other words, the image pickup apparatus according to the present disclosure may be applied to any device, such as a mobile device, a smartphone, or a network camera connected to a server, as long as it is equipped with an image pickup function and an image composition function and includes a user interface for setting the exposure time. In addition, it may be possible to cause a mobile device, a smartphone, or a network camera connected to a server to perform a part of the above-described processing.

According to the present disclosure, it is possible to perform natural exposure tracking in the case where the in-focus position has been moved by the MF operation.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc (BD)), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-204735, filed Nov. 25, 2024, which is hereby incorporated by reference herein in its entirety.

What is claimed is:

1. An image pickup apparatus including a lens unit equipped with a changing member for changing a current in-focus position by a user operation, the image pickup apparatus comprising:
an image sensor configured to capture an image; and
at least one processor or circuit and a memory storing instructions to cause the at least one processor or circuit to perform operations of the following units:
a detecting unit that detects subjects from the image;
a subject position obtaining unit that obtains information corresponding to positions of the subjects that have been detected by the detecting unit;
a calculating unit that calculates information about luminance of the subjects that have been detected by the detecting unit; and
a control unit that, in a case where a first subject and a second subject have been detected as the subjects by the detecting unit, obtains information corresponding to a position of the first subject and information corresponding to a position of the second subject by the subject position obtaining unit, calculates information about luminance of the first subject and information about luminance of the second subject by the calculating unit, and performs exposure control when an in-focus position moves based on the information about the luminance of the first subject, the information about the luminance of the second subject, the information corresponding to the position of the first subject, and the information corresponding to the position of the second subject.

2. The image pickup apparatus according to claim 1, wherein
the subject position obtaining unit obtains the information corresponding to the positions of the subjects that have been detected by the detecting unit, from distances between the subjects that have been detected by the detecting unit and the image pickup apparatus, which have been obtained from either focus information or time-of-flight (ToF) information.

3. The image pickup apparatus according to claim 1, wherein
the exposure control by the control unit is executed when a focus setting is an MF mode, in which a user manually adjusts the in-focus position.

4. The image pickup apparatus according to claim 1, wherein
a focus setting is an AF mode, in which the in-focus position is automatically adjusted, and further includes a first mode, in which the current in-focus position is changed in a case where a user operation on the changing member has been performed, and
the exposure control by the control unit is executed in a case where the focus setting is the first mode and it is during the user operation.

5. The image pickup apparatus according to claim 1, wherein
the at least one processor or circuit is caused to further perform operations of a setting unit that sets a tracking start threshold value and a tracking end threshold value of exposure in accordance with the information corresponding to the position of the first subject, the information corresponding to the position of the second subject, and a depth of field, and
the control unit, in a case where the current in-focus position is between the tracking start threshold value and the tracking end threshold value, performs the exposure control based on the information about the luminance of the first subject, the information about the luminance of the second subject, the information corresponding to the position of the first subject, and the information corresponding to the position of the second subject.

6. The image pickup apparatus according to claim 5, wherein
the setting unit, in a case where the position of the first subject is closer to the image pickup apparatus than the position of the second subject, sets the tracking start threshold value in accordance with the position of the first subject and the depth of field, and sets the tracking end threshold value in accordance with the position of the second subject and the depth of field,
in a case where the current in-focus position is smaller than the tracking start threshold value, the exposure control is performed based on the information about the luminance of the first subject, and
in a case where the current in-focus position is greater than the tracking end threshold value, the exposure control is performed based on the information about the luminance of the second subject.

7. The image pickup apparatus according to claim 6, wherein
the control unit adjusts values of the tracking start threshold value and the tracking end threshold value in accordance with a difference between the information about the luminance of the first subject and the information about the luminance of the second subject.

8. The image pickup apparatus according to claim 6, wherein
the at least one processor or circuit is caused to further perform operations of a display control unit that displays, on a display unit, information indicating respective relative positions of the position of the first subject, the position of the second subject, the tracking start threshold value, and the tracking end threshold value with respect to the image pickup apparatus,
a first icon for adjusting the tracking start threshold value by a user operation is provided at the relative position of the tracking start threshold value, and
a second icon for adjusting the tracking end threshold value by a user operation is provided at the relative position of the tracking end threshold value.

9. The image pickup apparatus according to claim 1, wherein
the at least one processor or circuit is caused to further perform operations of a selecting unit that, in a case where three or more subjects have been detected as the subjects by the detecting unit, selects two subjects from among the three or more detected subjects, and
one of the two subjects that have been selected by the selecting unit is set as the first subject, and the other is set as the second subject.

10. The image pickup apparatus according to claim 9, wherein
the at least one processor or circuit is caused to further perform operations of a display control unit that displays, on a display unit, an image in which user-selectable frames are respectively attached to the three or more subjects that have been detected by the detecting unit, and
the selecting unit selects, as the two subjects, subjects to which two frames user-selected from among the displayed frames are attached respectively.

11. The image pickup apparatus according to claim 9, wherein
the selecting unit selects, as the first subject, a subject closest to the current in-focus position in a depth direction from among the three or more subjects, and selects the second subject from remaining subjects.

12. The image pickup apparatus according to claim 11, wherein
the selecting unit calculates a priority for each of the remaining subjects by using a preset priority calculation method, and selects, as the second subject, a subject with the highest calculated priority from among the remaining subjects.

13. The image pickup apparatus according to claim 12, wherein
the at least one processor or circuit is caused to further perform operations of an average value calculating unit that, in a case where there are a plurality of subjects with the highest calculated priority among the remaining subjects, calculates an average value of respective photometric values of the plurality of subjects.

14. The image pickup apparatus according to claim 1, wherein
the at least one processor or circuit is caused to further perform operations of a tracking speed calculating unit that calculates an exposure tracking speed, and
the control unit, in a case where the exposure tracking speed exceeds a preset upper limit value, performs the exposure control when the in-focus position moves, based on the upper limit value.

15. An exposure control method for an image pickup apparatus including a lens unit equipped with a changing member for changing a current in-focus position by a user operation, the exposure control method comprising:
an imaging step of capturing an image;
a detecting step of detecting subjects from the image;
a subject position obtaining step of obtaining information corresponding to positions of the subjects that have been detected in the detecting step;
a calculating step of calculating information about luminance of the subjects that have been detected in the detecting step; and
a control step of, in a case where a first subject and a second subject have been detected as the subjects in the detecting step, obtaining information corresponding to a position of the first subject and information corresponding to a position of the second subject in the subject position obtaining step, calculating information about luminance of the first subject and information about luminance of the second subject in the calculating step, and performing exposure control when an in-focus position moves based on the information about the luminance of the first subject, the information about the luminance of the second subject, the information corresponding to the position of the first subject, and the information corresponding to the position of the second subject.

16. A non-transitory computer-readable storage medium storing a program for causing a computer to execute an exposure control method for an image pickup apparatus including a lens unit equipped with a changing member for changing a current in-focus position by a user operation, the exposure control method comprising:
an imaging step of capturing an image;
a detecting step of detecting subjects from the image;
a subject position obtaining step of obtaining information corresponding to positions of the subjects that have been detected in the detecting step;
a calculating step of calculating information about luminance of the subjects that have been detected in the detecting step; and
a control step of, in a case where a first subject and a second subject have been detected as the subjects in the detecting step, obtaining information corresponding to a position of the first subject and information corresponding to a position of the second subject in the subject position obtaining step, calculating information about luminance of the first subject and information about luminance of the second subject in the calculating step, and performing exposure control when an in-focus position moves based on the information about the luminance of the first subject, the information about the luminance of the second subject, the information corresponding to the position of the first subject, and the information corresponding to the position of the second subject.
